(19) United States
(12) Patent Application Publication
(10) Pub. No.: US 2023/0255187 A1
(43) Pub. Date: Aug. 17, 2023

(54) WEARABLE CONTAINER SYSTEMS

(71) Applicants: Anthony Brown, Golden, CO (US); Brad DeBeer, Golden, CO (US)

(72) Inventors: Anthony Brown, Golden, CO (US); Brad DeBeer, Golden, CO (US)

(21) Appl. No.: 17/670,307

(22) Filed: Feb. 11, 2022

(51) Int. Cl. A01K 97/06; A45F 3/00

(52) U.S. Cl. CPC A01K 97/06; A45F 3/00; A45F 2003/006; A45F 2003/003

(57) ABSTRACT

Wearable container systems for containing items. The wearable container systems include a strap and a container. The strap is configured to operatively secure to a person. The container is coupled to the strap and includes a body and an insert. The insert is disposed within the body. The insert is configured to support the items.

### BACKGROUND

The present disclosure relates generally to containers. In particular, wearable container systems for containing items are described.

A common problem faced in a variety of different contexts is storing items on one's person in a convenient and accessible manner. Placing items in a pocket or in a satchel is an existing approach, but retrieving items from a pocket or satchel can be slow, cumbersome, and/or require two hands. Requiring two hands can force one to set down something he or she is holding to access an item.

One specific context where storing and accessing items is necessary is fly fishing. Fly fishing utilizes lures, known as flies, cast into the water on a fishing line. A person fly fishing will often have a plurality of flies, including different types of flies and possibly multiple flies of the same type. The fly fisherman will select and use various flies throughout a fishing session. Typically, flies are contained in a container placed inside a bag.

Storing flies in a container placed in a bag is inconvenient and less than ideal for a variety of reasons. Accessing flies inside a box located within a bag is slow and cumbersome. Further, accessing the flies require two hands to access. Requiring two hands means the person fishing has to set down his or her fishing pole or awkwardly attempt to hold the fishing pole between an arm and torso to access a fly.

It would be desirable to have a container for flies or other small items that was convenient to use and that did not require two hands. There exists a need for wearable container systems that improve upon and advance the design of known containers. Examples of new and useful wearable container systems relevant to the needs existing in the field are discussed below.

### SUMMARY

The present disclosure is directed to wearable container systems for containing items. The wearable container systems include a strap and a container. The strap is configured to operatively secure to a person. The container is coupled to the strap and includes a body and an insert. The insert is disposed within the body. The insert is configured to support the items.

### BRIEF DESCRIPTION OF THE DRAWINGS

FIG. 1 is a top, left-side perspective view of a wearable container system on a person's wrist supporting a plurality of fly fishing lures with a lid open to an access position.

FIG. 2 is a top plan view of the wearable container system shown in FIG. 1.

FIG. 3 is a side elevation view of the wearable container system shown in FIG. 1.

FIG. 4 is a bottom view of the wearable container system shown in FIG. 1.

FIG. 5 is a front view of the wearable container system shown in FIG. 1 floating on water.

FIG. 6 is a top, right-side perspective view of the wearable container system shown in FIG. 1 floating on water.

### DETAILED DESCRIPTION

The disclosed wearable container systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various wearable container systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Wearable Container Systems

With reference to the figures, wearable container systems will now be described. The wearable container systems discussed herein function to contain small items and to be worn on one's person. The reader will appreciate from the figures and description below that the presently disclosed wearable container systems address many of the shortcomings of conventional containers.

For example, the novel wearable container systems described below provide a container for flies or other small items that is convenient to use and that does not require two hands to use. The novel wearable container systems described herein provide a superior alternative to storing items in a box disposed within a bag. With the novel wearable container systems described in this document, one can access stored items without setting down a fishing pole or other item being held at a given time.

Contextual Details

Ancillary features relevant to the wearable container systems described herein will first be described to provide context and to aid the discussion of the wearable container systems.

Stored Items

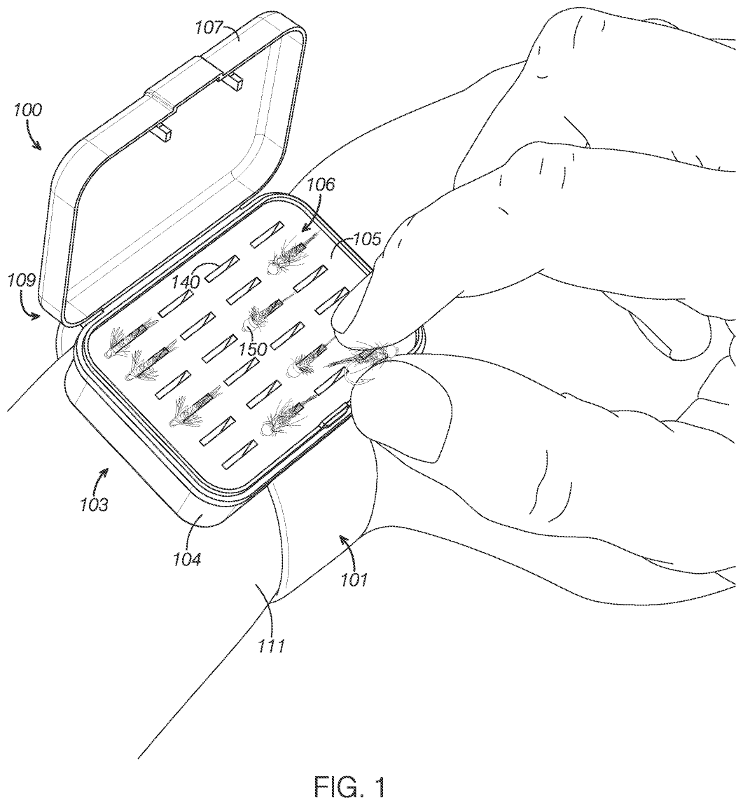

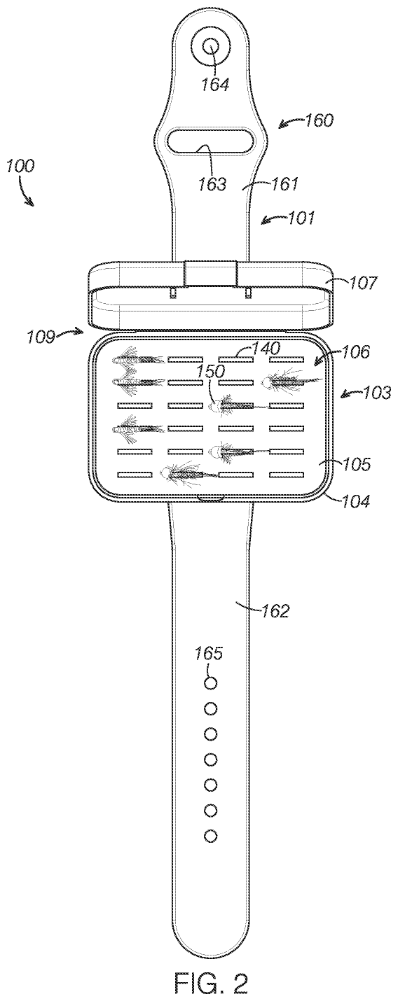

The wearable container systems described herein are often used to contain items, such as fly fishing lures 150 depicted in FIGS. 1 and 2. Fishing lures for fly fishing are one common example of an item that can be contained by the wearable container systems described herein. In examples where the wearable container systems contain fishing lures, the fishing lures may be any currently known or later developed type of fishing lure.

The reader should understand that the container systems described in this document could be used to store items other than fishing lures. For example, the wearable container systems may contain keys, money, credit cards, golf tees, and a wide variety of other items.

Wearable Container System Embodiment One

With reference to FIGS. 1-6, a wearable container system 100 will now be described as a first example of a wearable container system. The reader can see in FIGS. 1 and 2 that wearable container system 100 functions to store fly fishing lures 150. As shown in FIG. 1, wearable container system 100 may be worn on a wrist 111. Wearable container system 100 may be described as a bracelet fly-box and/or a fly-box watch.

In the example shown in FIGS. 1-6, wearable container system 100 includes a strap 101 and a container 103. In other examples, the wearable container system includes fewer components than depicted in the figures. In certain examples, the wearable container system includes additional or alternative components than depicted in the figures.

In the present example, wearable container system is waterproof. However, not all examples of the wearable container system will be waterproof.

Strap

As depicted in FIG. 1, strap 101 configured to secure to a person. With reference to FIG. 1, strap 101 is configured to extend around an arm 151 of person 102. As shown in FIG. 1, strap 101 is configured to extend around a wrist 111 of the person. In some examples, the strap secures around a forearm, bicep, leg, neck, or head of the person.

Of course, strap 101 could be secured to features on one's person rather than to the person's body. For example, strap 101 could secure to a belt, a belt loop, and/or a backpack strap.

As shown in FIGS. 2, 3, and 6, strap 101 includes an adjustment system 160. Adjustment system 160 includes a first strap 161, a second strap 162, a slot 163, a projection 164, and adjustment holes 165. In other examples, the adjustment system is configured differently, such as with a buckle, clasp, magnetic couplers, hook and loop fasteners, spring-loaded compressors, or elastic materials.

First strap 161 and second strap 162 are secured to opposite sides of container 103. First strap 161 includes projection 164 and slot 163 whereas second strap 162 defines adjustment holes 165.

With reference to FIGS. 1-3 and 6, strap 101 has a strap length. The reader can see in FIGS. 2, 3, and 6 that an effective length of strap 101 is adjustable via adjustment system 160. Adjustment system 160 functions by selectively fixing how much first strap 161 and second strap 162 overlap. Second strap 162 extends through slot 163 defined in first strap 161 and is fixed in a desired position relative to first strap 161 by coupling projection 164 with a given adjustment hole 165.

As depicted in FIG. 1, strap 101 and container 103 cooperate to enable fly fishing lures 150 to be supported by or removed from insert 105 with a single hand of the person.

The strap may be any currently known or later developed type of strap. The reader will appreciate that a variety of strap types exist and could be used in place of the strap shown in the figures. In addition to the types of straps existing currently, it is contemplated that the wearable container systems described herein could incorporate new types of straps developed in the future.

The size and shape of the strap may be vaned as needed for a given application. In some examples, the strap is larger relative to the other components than depicted in the figures. In other examples, the strap is smaller relative to the other components than depicted in the figures. Further, the reader should understand that the strap and the other components may all be larger or smaller than described herein while maintaining their relative proportions.

In the present example, the strap is composed of silicone rubber. However, the strap may be composed of any currently known or later developed material suitable for the applications described herein for which it is used. Suitable materials include cloth, metals, leather, cord, polymers, ceramics, wood, and composite materials.

Container

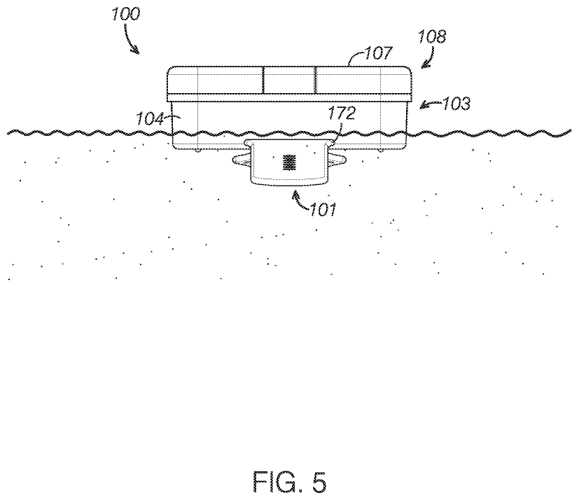

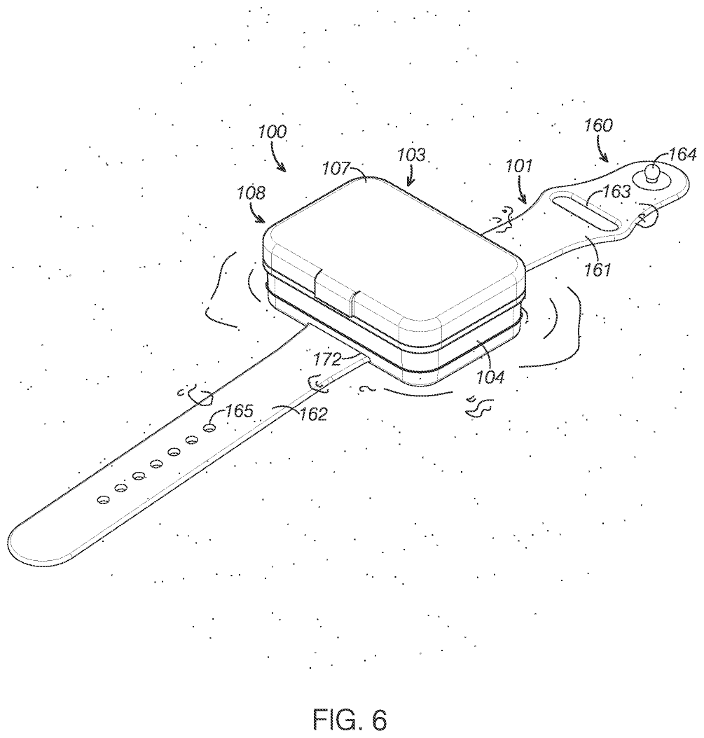

Container 103 functions to contain fly fishing lures 150. In the present example, as depicted in FIGS. 5 and 6, container 103 is configured to float on water to aid in retrieving the system in the event the system happens to fall into the water. However, not all examples of the container or wearable container system are configured to float on water.

As shown in FIGS. 1-6, container 103 is coupled to strap 101. As can be seen in FIG. 1, container 103 is secured to wrist 111 via strap 101 in a convenient position to present fly fishing lures 150 contained within it for inspection and access.

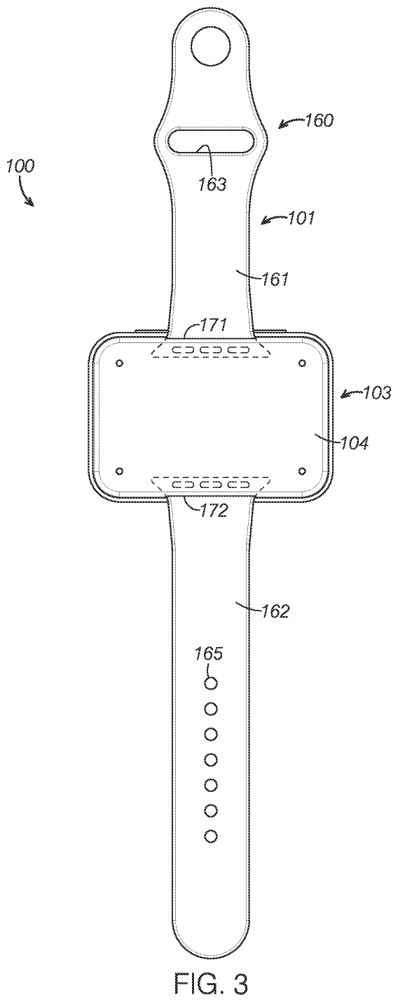

With reference to FIG. 3, container 103 defines a first strap opening 171 and a second strap opening 172. As shown in FIGS. 3, 5, and 6, container 103 receives strap 101 in first strap opening 171 and second strap opening 172 when coupling to strap 101. In particular, first strap opening 171 receives first strap 161 and second strap opening 172 receives second strap 162. The reader can see in FIG. 3 that first strap 161 flares outwards wider than first strap opening 171 to retain first strap 161 within first strap opening 171 unless manually removed. Second strap 162 and second strap opening 172 are configured similarly.

With reference to FIGS. 1 and 2, container 103 includes a body 104, an insert 105, and a lid 107. The components of container 103 are discussed in more detail in the sections below.

As depicted in FIGS. 1-3 and 6, container 103 has a container length. The reader can see in FIGS. 1-3 and 6 that the container length and the strap length extend transverse to each other.

The container may be any currently known or later developed type of container. The reader will appreciate that a variety of container types exist and could be used in place of the container shown in the figures. In addition to the types of containers existing currently, it is contemplated that the wearable container systems described herein could incorporate new types of containers developed in the future.

The number of containers in the wearable container system may be selected to meet the needs of a given application. The reader should appreciate that the number of containers may be different in other examples than is shown in the figures. For instance, some wearable container system examples include additional or fewer containers than described in the present example.

Body

The size and shape of the body may be varied as needed for a given application. For example, the body may be oval or round in some examples instead of rectangular as depicted in the figures. The body may be square, triangular, or any other regular polygon shape. Alternatively, the body may be an irregular shape.

In some examples, the body is larger relative to the other components than depicted in the figures. In other examples, the body is smaller relative to the other components than depicted in the figures. Further, the reader should understand that the body and the other components may all be larger or smaller than described herein while maintaining their relative proportions.

In the present example, body 104 is composed of plastic. However, the body may be composed of any currently known or later developed material suitable for the applications described herein forwhich it is used. Suitable materials include metals, polymers, ceramics, wood, and composite materials.

Insert

As shown in FIGS. 1 and 2, insert 105 is configured to support fly fishing lures 150. In particular, as shown in FIGS. 1 and 2, insert 105 is configured to support a plurality of fly fishing lures 150. As depicted in FIGS. 1 and 2, insert 105 defines slits 140 complementarily configured with fly fishing lures 150 to stably receive fly fishing lures 150.

The reader can see in FIGS. 1 and 2 that insert 105 is disposed within body 104. As shown in FIGS. 1, 2, and 4, insert 105 is selectively enclosed by body 104 and lid 107. In the particular example depicted in FIGS. 1 and 2, insert 105 is adhered to body 104. However, any means of supporting the insert in the body may be used, such as a friction fit, mechanical fasteners, or magnetic coupling.

The size and shape of the insert may be varied as needed for a given application. In some examples, the insert is larger relative to the other components than depicted in the figures. In other examples, the insert is smaller relative to the other components than depicted in the figures. Further, the reader should understand that the insert and the other components may all be larger or smaller than described herein while maintaining their relative proportions.

In the present example, insert 105 is comprised of foam. However, the insert may be composed of any currently known or later developed material suitable for the applications described herein for which it is used. Suitable materials include metals, tack, polymers, ceramics, wood, and composite materials.

Slit

Slits 140 functions to receive and support fly fishing lures 150. As depicted in FIGS. 1 and 2, slits 140 are arranged in an array 106 for organizing fly fishing lures 150.

The number of slits in the wearable container system may be selected to meet the needs of a given application. The reader should appreciate that the number of slits may be different in other examples than is shown in the figures. For instance, some wearable container system examples include additional or fewer slits than described in the present example.

The size and shape of the slits may be varied as needed for a given application. In some examples, the slits are larger relative to the other components than depicted in the figures. In other examples, the slits are smaller relative to the other components than depicted in the figures. Further, the reader should understand that the slits and the other components may all be larger or smaller than described herein while maintaining their relative proportions.

Lid

The role of lid 107 is to selectively cover container 103. The reader can see in FIGS. 1, 2 and 4-6 that lid 107 is coupled to body 104 of container 103. In particular, with reference to FIGS. 1, 2, and 4, lid 107 is pivotally coupled to body 104.

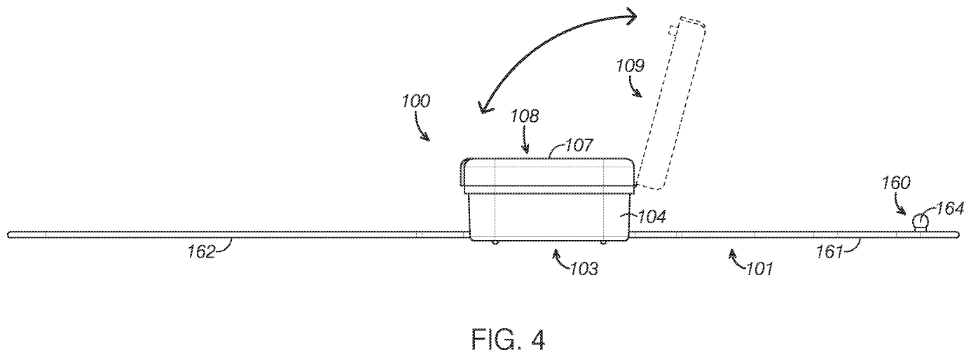

As shown in FIGS. 1, 2, and 4, lid 107 is configured to pivot between a cover position 108 and an access position 109. The reader can see in FIGS. 1, 2, and 4 that insert 105 is accessible within body 104 when lid 107 is in access position 109. As depicted in FIGS. 4-6, insert 105 is enclosed by lid 107 and body 104 when lid 107 is in cover position 108. The reader can see in FIGS. 1 and 4 that lid 107 is configured to pivot between cover position 108 and access position 109 when manipulated by a single hand of person 102.

The lid may be any currently known or later developed type of lid. The reader will appreciate that a variety of lid types exist and could be used in place of the lid shown in the figures. In addition to the types of lids existing currently, it is contemplated that the wearable container systems described herein could incorporate new types of lids developed in the future.

The size and shape of the lid may be varied as needed for a given application. In some examples, the lid is larger relative to the other components than depicted in the figures. In other examples, the lid is smaller relative to the other components than depicted in the figures. Further, the reader should understand that the lid and the other components may all be larger or smaller than described herein while maintaining their relative proportions.

In the present example, lid 107 is composed of plastic. However, the lid may be composed of any currently known or later developed material suitable for the applications described herein for which it is used. Suitable materials include metals, polymers, ceramics, wood, and composite materials.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A wearable container system for fly fishing lures, comprising:
a strap configured to operatively secure to a person; and
a container coupled to the strap;
wherein the container includes:
a body; and
an insert disposed within the body; and
wherein the insert is configured to support the fly fishing lures.

2. The wearable container system of claim 1, wherein the insert is comprised of foam.

3. The wearable container system of claim 1, wherein the insert defines slits complementarily configured with the fly fishing lures to stably receive the fly fishing lures.

4. The wearable container system of claim 3, wherein the slits are arranged in an array for organizing the fly fishing lures.

5. The wearable container system of claim 1, wherein the container includes a lid coupled to the body.

6. The wearable container system of claim 5, wherein the insert is selectively enclosed by the body and the lid.

7. The wearable container system of claim 6, wherein the lid is pivotally coupled to the body.

8. The wearable container system of claim 7, wherein:
the lid is configured to pivot between a cover position and an access position;
the insert is enclosed by the lid and the body when the lid is in the cover position; and
the insert is accessible within the body when the lid is in the cover position.

9. The wearable container system of claim 8, wherein the lid is configured to pivot between the cover position and the access position when manipulated by a single hand of the person.

10. The wearable container system of claim 1, wherein the strap is configured to extend around an arm of the person.

11. The wearable container system of claim 10, wherein the strap is configured to extend around a wrist of the person.

12. The wearable container system of claim 1, wherein an effective length of the strap is adjustable.

13. The wearable container system of claim 1, wherein the strap and the container cooperate to enable the fly fishing lures to be supported by or removed from the insert with a single hand of the person.

14. The wearable container system of claim 1, wherein the container is configured to float on water.

15. The wearable container system of claim 1, wherein the insert is adhered to the body.

16. The wearable container system of claim 1, wherein:
the container defines a strap opening; and
the container receives the strap in the strap opening when coupling to the strap.

17. The wearable container system of claim 1, wherein:
the container has a container length;
the strap has a strap length; and
the container length and the strap length extend transverse to each other.

18. The wearable container system of claim 1, wherein the insert is configured to support a plurality of fly fishing lures.

19. A wearable container system for fly fishing lures, comprising:
a strap configured to form a loop; and
a container coupled to the strap;
wherein the strap is configured to secure around a first arm of a person by receiving the first arm in the loop;
wherein the container is configured to support the fly fishing lures in a manner accessible by a single hand on a second arm of the person.

20. The wearable container system of claim 20, wherein:
the container includes:
a body; and
an insert disposed within the body; and
the insert is configured to support the fly fishing lures.
